(19) United States
(12) Patent Application Publication
(10) Pub. No.: US 2014/0356647 A1
(43) Pub. Date: Dec. 4, 2014

(54) ALUMINUM ALLOY CLAD MATERIAL FOR FORMING

(71) Applicant: UACJ CORPORATION, Tokyo (JP)

(72) Inventors: Hiroki Takeda, Tokyo (JP); Akira Hibino, Tokyo (JP)

(73) Assignee: UACJ CORPORATION, Tokyo (JP)

(21) Appl. No.: 14/356,112

(22) PCT Filed: Oct. 31, 2012
(86) PCT No.: PCT/JP2012/078241

§ 371 Date: May 2, 2014

(30) Foreign Application Priority Data
Nov. 2, 2011 (JP) 2011-241444

(51) Int. Cl. B32B 15/01; C22C 21/16; C22C 21/14; C22C 21/02; C22C 21/08

(52) U.S. Cl. CPC B32B 15/016; C22C 21/02; C22C 21/08; C22C 21/14; C22C 21/16
USPC 428/654

(57) ABSTRACT

The aluminum alloy clad material for forming of the present disclosure includes: an aluminum alloy core material containing Mg: 0.2 to 1.5% (mass %, the same hereinafter), Si: 0.2 to 2.5%, Cu: 0.2 to 3.0%, and the remainder being Al and inevitable impurities; an aluminum alloy surface material which is cladded on one side or both sides the core material, the thickness of the clad for one side being 3 to 30% of the total sheet thickness, and which has a composition including Mg: 0.2 to 1.5%, Si: 0.2 to 2.0%, Cu being restricted to 0.1% or smaller, and the remainder being Al and inevitable impurities; and an aluminum alloy insert material which is interposed between the core material and the surface material, and has a solidus temperature of 590° C. or lower.

### TECHNICAL FIELD

The present disclosure relates to an aluminum alloy clad material for a forming which is subjected to a forming and paint-baking and used as a material for a variety of members or parts of automobiles, watercraft, aircraft, or the like such as an automotive body sheet or a body panel, or building materials, structural material, and a variety of machines and instruments, home electric appliances and parts thereof, or the like.

### BACKGROUND ART

Conventionally, as an automotive body sheet, a cold rolled steel sheet has been primarily used in many cases; recently, from the viewpoint of reducing the weight of the automotive body, or the like, an aluminum alloy rolled sheet is increasingly used.

By the way, an automotive body sheet needs to have a good formability since an automotive body sheet is subjected to press working to be used; an automotive body sheet needs to have a good formability, among others, a good hemming workability since, in many cases, an automotive body sheet is subjected to hemming to be used in order to bond an outer panel and an inner panel together. Further, since it is usual that an automotive body sheet is subjected to paint-baking to be used, an automotive body sheet needs to attain a high strength after paint-baking in cases in which strength is emphasized in the balance between formability and strength; on the other hand, in cases in which the formability is emphasized, an automotive body sheet needs to attain an excellent press formability by compromising the strength to some extent after paint-baking. Still further, an aluminum alloy sheet for an automotive body sheet needs to have a sufficient corrosion resistance (intergranular corrosion resistance, filiform corrosion resistance).

Conventionally for such an aluminum alloy for an automotive body sheet, Al—Mg based alloys, Al—Mg—Si based alloys or Al—Mg—Si—Cu based alloys with an age-hardening ability is usually used. Among these, Al—Mg—Si based alloys and Al—Mg—Si—Cu based alloys with an age-hardening ability have an advantage that the strength after paint-baking becomes high by age-hardening due to heating during paint-baking, as well as an advantage, for example, that Luders band is hardly generated, and thus is gradually becoming mainstream for an automotive body sheet material. However, since the press formability or hemming workability is poor compared to Al—Mg based alloys, a variety of studies for improving both the press formability and hemming workability have been conducted. For example, a large number of techniques such as control of the amount of Mg or Si which is a main component, addition of a component represented by Cu, control of second phase particles, control of the crystal grain size, and control of the texture are proposed.

On the other hand, in the case of, for example, an automotive body sheet in which a variety of performances such as press formability, hemming workability, strength, and corrosion resistance are needed, a sheet composed of one alloy may be hard to satisfy all needs. As means for solving such problems, use of a cladding material consisting of cladding sheet materials each having different properties as described in Patent Literature 1 is proposed.

### CITATION LIST

### Patent Literature

Patent Literature 1 National Patent Publication No. 2009-535510

### SUMMARY OF INVENTION

### Technical Problem

As an industrial production process for an aluminum alloy clad material, a method in which aluminum or aluminum alloy sheet materials are layered to bond the interface by hot rolling (hot rolled clad) is generally used, and the method is currently widely used in manufacturing of a blazing sheet which is used as a heat exchanger or the like. However, in cases in which Al—Mg—Si based alloys or Al—Mg—Si—Cu based alloys for an automotive body sheet is subjected to a clad rolling in accordance with an ordinary method, since an adhesion failure between a core material and a surface material is likely to occur, causing a variety of problems such as peeling at the joining interface, cladding ratio failure, abnormality of the quality in which the material surface swells locally, and decrease in the productivity of a cladding material, practical use thereof in a mass production scale is difficult.

The present disclosure is made in view of the above-mentioned circumstances, and directed to providing an aluminum alloy clad material for forming in which a high mass productivity is attained, as well as particularly good formability, paint-baking hardenability and corrosion resistance are obtained.

### Solution to Problem

In order to attain the above-mentioned objective, the aluminum alloy clad material for forming of the present disclosure comprises:

an aluminum alloy core material containing Mg: 0.2 to 1.5% (mass %, the same hereinafter), Si: 0.2 to 2.5%, Cu: 0.2 to 3.0%, and the remainder being Al and inevitable impurities;

an aluminum alloy surface material which is cladded on one side or both sides the core material, the thickness of the clad for one side being 3 to 30% of the total sheet thickness, and which has a composition including Mg: 0.2 to 1.5%, Si: 0.2 to 2.0%, Cu being restricted to 0.1% or smaller, and the remainder being Al and inevitable impurities; and

an aluminum alloy insert material which is interposed between the core material and the surface material, and has a solidus temperature of 590° C. or lower.

Preferably, in the aluminum alloy clad material for forming,

the core material and the surface material, or either thereof contains one or more of Mn: 0.03 to 1.0%, Cr: 0.01 to 0.40%, Zr: 0.01 to 0.40%, V: 0.01 to 0.40%, Fe: 0.03 to 1.0%, Zn: 0.01 to 2.5%, and Ti: 0.005 to 0.30%.

Preferably, in the aluminum alloy clad material for forming,

setting the amount of Si (mass %, the same hereinafter) contained in the insert material to x and the amount of Cu (mass %, the same hereinafter) contained in the insert material to y, the following expressions (1) to (3) are satisfied at the same time:

x≧0 (1)

y≧0 (2)

y≧−15.3x+2.3 (3).

Preferably, in the aluminum alloy clad material for forming,

the amount of Mg contained in the insert material is 0.05 to 2.0 mass %, and

setting the amount of Si (mass %, the same hereinafter) contained in the insert material to x, and the amount of Cu (mass %, the same hereinafter) contained in the insert material to y, the following expressions (4) to (6) are satisfied at the same time:

x≧0 (4)

y≧0 (5)

y≧−x+0.01 (6).

Preferably, in the aluminum alloy clad material for forming,

the solidus temperature of the insert material is lower than the solidus temperature of the core material and the solidus temperature of the surface material.

Preferably, in the aluminum alloy clad material for forming,

the thickness of the insert material when the core material, the insert material and the surface material are bonded in a high-temperature heat treatment is 10 μm or larger.

### Advantageous Effects of Invention

According to the present disclosure, since an adhesion failure of Al—Mg—Si based alloys or Al—Mg—Si—Cu based alloys by clad rolling can be effectively prevented, an aluminum alloy clad material for forming in which a high mass productivity is attained, as well as particularly good formability, paint-baking hardenability and corrosion resistance are obtained is obtained.

### BRIEF DESCRIPTION OF DRAWINGS

FIG. 1 is a phase diagram of Al—Si alloy showing the relationship between the composition and the temperature of an insert material; and

FIGS. 2A to 2D are pattern diagrams illustrating a generation process of a liquid phase of the insert material.

### DESCRIPTION OF EMBODIMENTS

In the following, an embodiment of the present disclosure will be specifically described.

In order to solve the above-mentioned problems, the present inventors have repeatedly performed a variety of experiments and studies to find that an adhesion failure can be prevented by bonding a core material and a surface material via an insert material before rolling, thereby completing the invention.

A core material and a surface material used for an aluminum alloy clad material of the disclosure is basically Al—Mg—Si based alloys or Al—Mg—Si—Cu based alloys, and the specific component composition thereof may be appropriately adjusted in accordance with a needed performance level. In cases in which formability, paint-baking hardenability and corrosion resistance are especially emphasized, the component composition is preferably adjusted in such a manner as in the embodiment. In the following, the reason for restricting the component composition of material alloy will be described.

<<Alloy Composition of Core Material>>

Mg:

Mg is a fundamental alloy component for alloy system which is a subject of the disclosure, and contributes to improvement of the strength in cooperation with Si. Since, when the amount of Mg is smaller than 0.20%, the amount of G.P. (Guinier-Preston) zone which contributes to improvement of the strength due to precipitation hardening at the time of paint-baking is small, a sufficient improvement in the strength is not obtained. On the other hand, when the amount of Mg is larger than 1.5 mass %, a coarse Mg—Si based intermetallic compound is generated, which decreases in the press formability. Therefore, the amount of Mg is in a range of 0.2 mass % to 1.5 mass %.

Si:

Si is also a fundamental component for alloy system which is a subject of the disclosure, and contributes to improvement of the strength in cooperation with Mg. Since Si based crystallized products are generated during casting, and the surrounding of metallic Si based crystallized products are deformed by working to be a nucleation site for a recrystallization during a solution treatment, Si also contributes to micronization of recrystallization structure. When the amount of Si is less than 0.20 mass %, the above-mentioned effect is not sufficiently obtained. On the other hand, the amount of Si is larger than 2.5 mass %, a coarse Si particle or coarse Mg—Si based intermetallic compound is generated, causing decrease in the press formability. Therefore, the amount of Si is in a range of 0.20 mass % to 2.5 mass %.

Cu:

Cu is a component which may be added in order to increase the strength and formability. When the amount of Cu is smaller than 0.20 mass % the above-mentioned effect is sufficiently obtained. On the other hand, when the amount of Cu is larger than 3.0 mass %, the strength becomes too high and the press formability deteriorates. Therefore, the content of Cu is restricted in a range of 0.20 mass % to 3.0 mass %.

In accordance with the purpose, one or more of Mn, Cr, Zr, V, Fe, Zn, and Ti may be added. These components are effective for improvement of the strength, micronization of a crystal grain, the age hardening (paint-baking hardenability), or the surface treatment performance.

Mn, Cr, Zr, V:

Mn, Cr, Zr, and V are a component which has an effect for improvement of the strength, micronization of a crystal grain, and stabilization of the structure. When the content of Mn is 0.03 mass % or higher or when each of the contents of Cr, Zr, V is 0.01 mass % or higher, the above-mentioned effect can be sufficiently obtained. When the content of Mn is 1.0 mass % or lower, or when each of the contents of Cr, Zr, V is 0.40 mass % or lower, the above-mentioned effect is sufficiently maintained and at the same time, an adverse effect on the formability due to generation of a large amount of intermetallic compound can be inhibited. Therefore, the amount of Mn is preferably in a range of 0.03 mass % to 1.0 mass %, and each of the contents of Cr, Zr, V is preferably in a range of 0.01 mass % to 0.40 mass %.

Fe:

Fe is also a component which is effective for improvement of the strength, and micronization of crystal grain. When the content of Fe is 0.03 mass % or higher, a sufficient effect can be obtained. When the content of Fe is 1.0 mass % or lower, deterioration of the press formability due to generation of a large amount of intermetallic compound can be inhibited. Therefore, the amount of Fe is preferably in a range of 0.03 mass % to 1.0 mass %.

Zn:

Zn is a component which contributes to improvement of the strength by improvement of the age hardening and at the same time, is effective for improving the surface treatment performance. When the amount of Zn added is 0.01 mass % or larger, the above-mentioned effect can be sufficiently obtained. When the amount of Zn added is 2.5 mass % or smaller, deterioration of the formability can be inhibited. Therefore, the amount of Zn is preferably in a range of 0.01 mass % to 2.5 mass %.

Ti:

Since Ti has an effect for improvement of the strength, prevention of surface roughing, and improvement of anti ridging characteristics of the final product sheet by micronization of ingot structure, Ti is added for micronization of an ingot structure. When the content of Ti is 0.005 mass % or higher, a sufficient effect can be obtained. When the content of Ti is 0.30 mass % or lower, generation of coarse crystallized product can be inhibited while maintaining the effect of addition of Ti. Therefore, the amount of Ti is preferably in a range of 0.005 mass % to 0.30 mass %. Since B is added together with Ti, by the addition of B together with Ti, the effect of micronization and stabilization of ingot structure becomes more evident. Also in the case of the disclosure, addition of B in an amount of 500 ppm or smaller together with Ti is preferably allowed.

The alloy material preferably comprises, other than the above-mentioned components, basically Al and inevitable impurities.

In Al—Mg—Si based alloys, Al—Mg—Si—Cu based alloys with age-hardening ability, Ag, In, Cd, Be, or Sn which is a component which accelerates high-temperature aging or a component which inhibits natural aging (room temperature) is sometimes added in a small amount. Also in the disclosure, these components are allowed to add in a small amount. When each of the amounts is 0.30 mass % or smaller, an expected objective is not particularly compromised. Further, it is known that the addition of Sc has an effect for micronization of ingot structure. Also in the case of the disclosure, a small amount of Sc may be added, and there is no problem in particular when the amount of Sc is preferably in a range of 0.01 mass % to 0.20 mass %.

<<Alloy Composition of Surface Material>>

Next, the reason for restricting the component composition of a surface material will be described. A surface material has a strong influence on corrosion resistance (intergranular corrosion resistance, filiform corrosion resistance), and hemming workability, and minimally required surface hardness as an automotive body sheet material. The range of alloy composition of the surface material is similar to that of the above-mentioned core material except that the amount of Si is restricted to 2.0 mass % or smaller and the amount of Cu is restricted to 0.1 mass % or smaller. In the following, the reason for restricting Si and Cu will be described.

Si:

Si is also a fundamental alloy component for alloy system which is a subject of the disclosure, and contributes to improvement of the strength in cooperation with Mg. Since Si is generated as a Si based crystallized product of metallic Si during casting and the surrounding of metallic Si based crystallized products particles are deformed by working to be a nucleation site for a recrystallization during a solution treatment, Si also contributes to micronization of recrystallization structure. When the amount of Si is less than 0.20 mass %, the above-mentioned effect is not sufficiently obtained. On the other hand, the amount of Si is larger than 2.0 mass %, a coarse Si particle or coarse Mg—Si based intermetallic compound is generated, causing decrease in the hemming workability. Therefore, the amount of Si is in a range of 0.20 mass % to 2.0 mass %.

Cu:

Cu is a component which may be added in order to increase the strength and formability. Since, when the amount of Cu is larger than 0.1 mass %, corrosion resistance (intergranular corrosion resistance, filiform corrosion resistance) deteriorates, the content of Cu is restricted to 0.1 mass % or lower.

In cases in which the hemming workability is especially emphasized, the component composition of each alloy is more preferably limited to the following range:

the amount of Mg: 0.20 mass % to 1.0 mass %,

the amount of Si: 0.20 mass % to 1.5 mass %,

the amount of Mn: 0.03 mass % to 0.60 mass %, and

the amount of Fe: 0.03 mass % to 0.60 mass %.

Further, in cases in which the corrosion resistance is especially emphasized, the amount of Cu is more desirably restricted to 0.05 mass % or smaller.

The ratio of the sheet thickness of the surface material with respect to the total sheet thickness (cladding ratio) is 3 to 30% for one side, and the surface material is cladded on one side, or on both sides as needed. When the cladding ratio is below the lower limit of the above range, performances which the surface material is to exhibit represented by corrosion resistance, hemming workability, and the like are not sufficiently exhibited. When the cladding ratio is above the upper limit of the above range, performances which the core material is to exhibit represented by the press formability, paint-baking hardenability, and the like are largely deteriorated.

Next, an aluminum alloy insert material used for an aluminum alloy clad material of the disclosure will be described.

Basically, in cases in which a cladding material using Al—Mg—Si based alloy or Al—Mg—Si—Cu based alloy as a core material or surface material is manufactured by rolling, the core material and the surface material are likely to be peeled due to the influence of an oxide film existing on the surface of the alloy, or the difference between the defomation resistances of the core material and the surface material, which prevents the practical application thereof in a mass production scale. In the present disclosure, for the purpose of resolving an adhesion failure during clad rolling, an aluminum alloy insert material is inserted between the core material and the surface material. By a bonding method which utilizes a minute liquid phase which is generated inside the insert material by performing a high-temperature heating, the core material and the insert material, and the surface material and the insert material are individually bonded with each other metallically, thereby preventing interface peeling during rolling. Since, as the result, rolling is completed without generating interface peeling, a cladding material in which the bonded interface has no adhesion failure and which is tightly bonded can be surely and stably obtained in a mass production scale. Since such insertion of the insert material is useful for resolving an adhesion failure of an alloy of a kind in which clad rolling as mentioned above is difficult as well as for preventing an adhesion failure of an alloy of a kind in which cladding technique is established, the insertion is effective for improving the productivity or attaining a cladding ratio which is difficult to attain by a conventional method.

Here, the aluminum alloy insert material is expected to improve the adhesion failure. In cases in which Al—Mg—Si based alloy or Al—Mg—Si—Cu based alloy is used as a material of the core material and the surface material, in order to prevent bonded interface peeling during rolling, the sheet thickness of the insert material when the insert material and the core material, and surface material are individually bonded with each other by a high-temperature heat treatment is preferably 10 μm or larger. When the thickness is 10 μm or larger, an amount of liquid phase in which a favorable bonding is obtained is secured, and generation of interface peeling during rolling can be inhibited. When the thickness of the insert material is more preferably 50 μm or larger, and further preferably 100 μm or larger, bonded interface peeling can be more surely prevented. A preferred sheet thickness of an insert material for the purpose of preventing bonded interface peeling which has been described here does not change depending on the sheet thickness of the core material and the surface material, and the upper limit of the sheet thickness of the insert material is not particularly restricted. On the other hand, the existence of the insert material desirably has no influence on other properties such as the press formability, the hemming workability, the paint-baking hardenability, the corrosion resistance, or the surface quality. In this respect, the present inventors repeated experiments to find that, further suitably, the ratio of the insert material with respect to the total sheet thickness is 1% or lower for one side. In such a range of the sheet thickness, the properties of the insert material do not inhibit the effect of the core material or the surface material. For such a purpose, the lower limit value of the ratio of the insert material is not particularly limited. As mentioned above, the upper limit and the lower limit of the sheet thickness of the insert material are determined depending on separate purposes mentioned above. Preferably, the lower limit value and the upper limit value are set so as to satisfy a preferred sheet thickness during a high-temperature heat treatment and so as to satisfy a preferred ratio with respect to the total sheet thickness, respectively.

In the following, the mechanisms of generation of a liquid phase and bonding will be described in more detail.

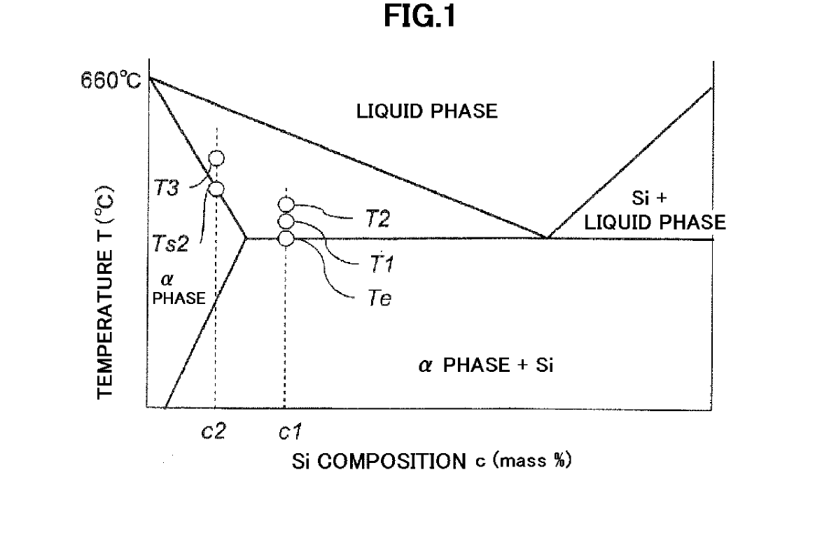

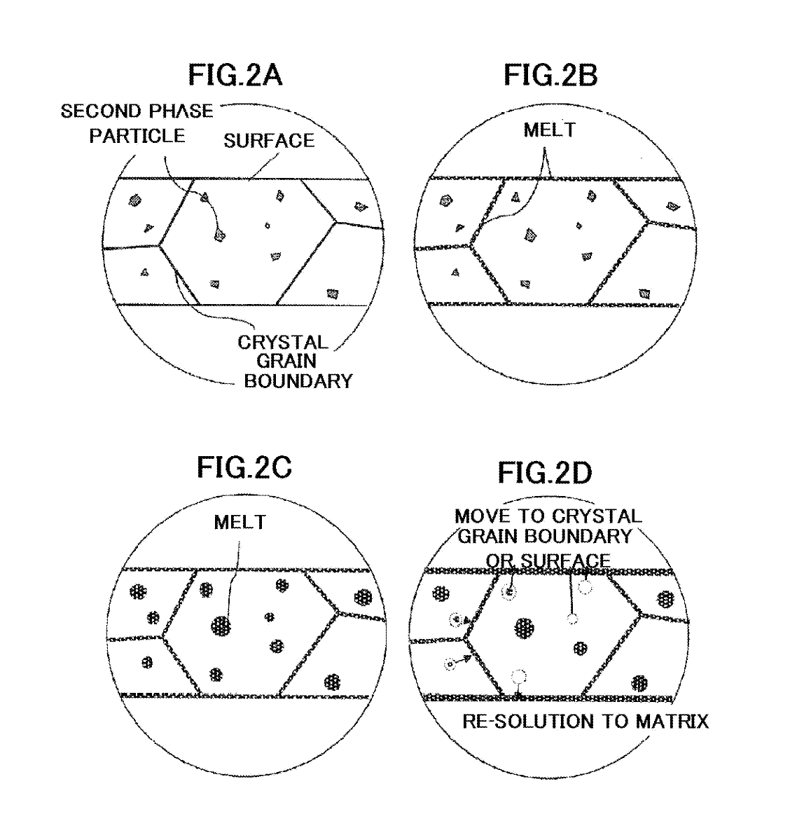

FIG. 1 schematically illustrates a phase diagram of Al—Si alloy which is a representative binary eutectic alloy. In cases in which the composition of the insert material has a Si composition of c1, after heating, generation of a liquid phase begins at a temperature of T1 near a temperature above the eutectic temperature (solidus temperature) Te. When the temperature is eutectic temperature Te or lower, as illustrated in FIG. 2A, second phase particle is distributed in a matrix sectioned by a crystal grain boundary. Here, when generation of the liquid phase begins, as illustrated in FIG. 2B, the crystal grain boundary on which there is a large amount of precipitate or the composition of a solid solution element is high due to intergranular segregation melts into a liquid phase. Subsequently, as illustrated in FIG. 2C, Si second phase particles which are a component added mainly dispersed in a matrix of an aluminum alloy, or the surrounding of intermetallic compounds are spherically molten into a liquid phase. Further, as illustrated in FIG. 2D, the spherical liquid phase generated in the matrix is re-soluble due to an interface energy with the passage of time or rise in the temperature, and moves to the crystal grain boundary or the surface by solid phase diffusion.

Next, as illustrated in FIG. 1, when the temperature rises to T2, the amount of liquid phase increases according to the phase diagram. As illustrated in FIG. 1, in cases in which the Si composition of the insert material is c2, generation of a liquid phase begins in the same manner as in c1 at a temperature near a temperature above a solidus temperature Ts2, and when the temperature rises to T3, the amount of liquid phase increases according to the phase diagram. As mentioned above, the liquid phase generated on the surface of the insert material during bonding fills a gap with the core material or the surface material, and then, the liquid phase near the bonded interface moves towards the core material or the surface material. With this movement, a crystal grain of the insert material's solid phase (alpha phase) grows toward inside of the core material or surface material, thereby attaining metal bonding. As mentioned above, the bonding method according to the present disclosure utilizes a liquid phase generated by partial melting inside the insert material.

In bonding of the present disclosure, in cases in which the sheet thickness of the insert material is in the range mentioned above, favorable bonding is attained if the temperature is a solidus temperature judged from an endothermic peak by Differential Thermal Analysis (DTA) or higher. In cases in which a bonding failure is desired to be more surely prevented, the mass ratio of the liquid phase is preferably 5% or higher, and more preferably 10% or higher. Even when the insert material is completely melt, there is no problem in the present disclosure, but the insert material is not needed to be completely melt.

As is obvious from the above, in cases in which metal bonding is not formed without heating up to the solidus temperature of the insert material even when the insert material is inserted, it becomes difficult to obtain a cladding material without an adhesion failure. The present inventors repeated experiments to find that, in order to attain favorable bonding without an adhesion failure, insertion of the insert material and heating to the solidus temperature of the insert material or above are needed.

Since Al—Mg—Si based alloy, Al—Mg—Si—Cu based alloy used as a core material, or a surface material may undergo eutectic melting accompanying performance deterioration at a temperature above 590° C., a high-temperature heat treatment performed before rolling is normally performed at a temperature of 590° C. or lower. Therefore, the solidus temperature of the aluminum alloy insert material needs to be 590° C. or lower. Since a small amount of a liquid phase needs to be generated, retention time for the high-temperature heating may be from 5 minutes to 48 hours. Further, from the viewpoint of energy saving, since the lower the temperature of the high-temperature heat treatment, the better, the solidus temperature of the insert material is preferably 570° C. or lower. Depending on the composition of the core material, or the surface material, it can be thought that the solidus temperature is 590° C. or lower, the high-temperature heat treatment is preferably performed at the solidus temperature of the core material or the surface material or lower in order to avoid deterioration in the performance of the cladding material. On the other hand, since, in order to prevent a bonding failure, as mentioned above, a high-temperature heating at the solidus temperature of the insert material or higher is needed to be performed, more preferably, the solidus temperature of the insert material is lower than each of the solidus temperatures of the core material and the surface material.

<<Alloy Composition of Insert Material>>

The solidus temperature of the aluminum alloy insert material used for an aluminum alloy clad material of the disclosure may be 590° C. or lower, and the specific component composition thereof is not particularly restricted, and, in view of productivity, Al—Cu based, Al—Si based or Al—Cu—Si based alloy is suitably used.

Here, both Cu and Si are a component which has an effect of considerably decreasing the solidus temperature by adding to aluminum. The present inventors studied a range of the composition in which a cladding material having a favorable performance without an adhesion failure is obtained when Al—Cu-based, Al—Si-based or Al—Cu—Si based alloy is used as the insert material to find that, setting the amount of Si to x, and the amount of Cu to y, the following expressions (1) to (3) are more preferably satisfied at the same time:

x≧0 (1)

y≧0 (2)

y≧−15.3x+2.3 (3)

Although the upper limit of Cu, Si is not particularly restricted in view of exhibiting functions of the insert material needed in the present disclosure, when the productivity such as castability, or rollability is taken into account, preferably Cu is 10 mass % or smaller, and Si is 15 mass % or smaller.

Examples of the other components having an effect that the solidus temperature is considerably decreased include Mg. In the present disclosure, Mg may be added to the above-mentioned Al—Cu based, Al—Si based, or Al—Cu—Si based alloy as needed. When the content of Mg is 0.05 mass % or higher, an effect of decreasing the solidus temperature can be sufficiently obtained; and when the content of Mg is 2.0 mass % or lower, interference bonding to the top surface of the insert material during a high-temperature heating due to formation of a thick oxide film is inhibited. Therefore, the amount of Mg is preferably in a range of 0.05 mass % to 2.0 mass %. Even when the above-mentioned Al—Cu based, Al—Si based, or Al—Cu—Si based alloy contains Mg in an amount smaller than the lower limit defined here, functions of the insert material are not compromised.

The present inventors studied in a similar manner a range of the composition in which a cladding material without an adhesion failure is obtained when Al—Cu based, Al—Si based or Al—Cu—Si based alloy is used as the insert material to find that, setting the amount of Si to x, and the amount of Cu to y, the following expressions (4) to (6) are more preferably satisfied at the same time:

x≧0 (4)

y≧0 (5)

y≧−x+0.01 (6)

Here, one or more components other than the above-mentioned Cu, Si, Mg such as Fe, Mn, Sn, Zn, Cr, Zr, Ti, V, B, Ni, and Sc are allowed to be contained to a degree that functions of the insert material are not inhibited. More particularly, Fe, Mn may be added in an amount of 3.0 mass % or smaller; Sn, Zn may be added in an amount of 10.0 mass % or smaller; and Cr, Zr, Ti, V, B, Ni, Sc may be added in an amount of 1.0 mass % or smaller for the purpose of improving castability, rollability, or the like. In the same manner inevitable impurities are allowed to be contained.

Next, a manufacturing method of an aluminum alloy sheet for a forming of the disclosure will be described.

Each of the core material, surface material, and insert material which constitute an aluminum alloy cladding material of the present disclosure may be manufactured in accordance with an ordinary method. For example, first, an aluminum alloy having a component composition as mentioned above is manufactured in accordance with a conventional method, and subjected to casting by appropriately selecting a normal casting such as continuous casting, or semi-continuous casting (DC casting). In cases in which the thickness needs to be reduced to obtain a predetermined sheet thickness, a homogenizing treatment is performed as needed, and then hot rolling or cold rolling, or both thereof may be performed. Other than the above, a predetermined sheet thickness may be obtained by machine cutting or a combination of rolling and machine cutting, or the like.

Subsequently, the core material, surface material, insert material having a predetermined sheet thickness are layered such that the insert material is inserted between the core material and the surface material. The surface material and the insert material may be layered on one side, or both sides as needed. For the purpose of removing an oxide film at the bonded interface, a flux may be applied to the bonded portion as needed. In the present disclosure, however, bonded interface peeling can be sufficiently prevented during rolling even without applying a flux. As needed, the core material, surface material, and insert material after layering may be fixed by welding. Welding may be performed in accordance with a conventional method, and it is preferably performed, for example, in conditions of an electric current of 10 to 400 A, a voltage of 10 to 40V, and a welding speed of 10 to 200 cm/min. Still further, fixation of the core material, surface material, and insert material by a fixing instrument such as an iron band causes no problems. After layering, a high-temperature heating for bonding utilizing a liquid phase of the insert material is performed as mentioned above. More efficiently, the high-temperature heating is performed also as a homogenizing treatment which is normally performed for Al—Mg—Si based or Al—Mg—Si—Cu based alloy which constitutes the core material and surface material. Here, the high-temperature heat treatment also used as a homogenizing treatment is performed at a temperature which is at least the solidus temperature of the insert material or higher. As mentioned above, the temperature is 590° C. or lower depending on the solidus temperature of the insert material, and preferably at a temperature 570° C. or lower. The retention time may be 5 minutes to 48 hours. When the retention time is 5 minutes or longer, favorable bonding can be obtained. When the retention time is 48 hours or shorter, a heating treatment can be performed economically with maintaining the above effect. Although the high-temperature heat treatment can be sufficiently performed under an oxidizing atmosphere such as under an atmospheric furnace, in order to more surely preventing interface peeling, the high-temperature heat treatment is preferably performed under a non-oxidizing atmosphere in which an oxidizing gas such as oxide is not contained. Examples of the non-oxidizing atmosphere include vacuum, inert atmosphere and reducing atmosphere. The inert atmosphere refers to an atmosphere filled with an inert gas such as nitrogen, argon, helium, or neon. The reducing atmosphere refers to an atmosphere in which a reducing gas such as hydrogen, monoxide, or ammonium exists. In order to have a sufficient homogenizing treatment effect by a heating treatment, the lower limit of the temperature may be 480° C. or higher, and more preferably, 490° C. or higher. Still further, in order to obtain high paint-baking hardenability, after heating and retention, cooling is preferably performed in a temperature range less than 450° C. at an average cooling rate of 50° C./h or higher. After the homogenizing treatment, hot rolling or cold rolling, or both thereof are performed in accordance with normal conditions to obtain a cladding material having a predetermined sheet thickness. The process annealing may be performed as needed.

Subsequently, the obtained rolled sheet is subjected to a solution treatment which also functions as a recrystallization treatment. In the solution treatment, the material attainable temperature is from 500° C. to 590° C., and the retention time at the material attainable temperature is more preferably five minutes to zero. Here, by setting the intermediate temperature between the solidus temperature and the liquidus temperature to Tc, and heating in a temperature range less than Tc, a strong melting of an insert layer does not occur, and deterioration of properties of the material can be inhibited, and therefore, the material attainable temperature is preferably lower than Tc also in the above range. The upper limit of the material attainable temperature when a process annealing is performed as needed is more desirably 590° C. or lower and lower than Tc. Although time for the solution treatment is not particularly restricted, when the time is five minutes or shorter, a solution treatment can be performed economically while maintaining the solution effect, as well as coarsening of crystal grain can be inhibited; and therefore, the time for the solution treatment is more desirably five minutes or shorter.

Cooling (quenching) after the solution treatment is preferably performed at a cooling rate of 100° C./min or higher in a temperature range of 150° C. or lower in order to prevent a large amount of precipitation of Mg₂Si, elemental Si, or the like at the grain boundary during cooling. Here, when the cooling rate after the solution treatment is 100° C./min or higher, the press formability, in particular, the bendability can be maintained high, and at the same time deterioration of the paint-baking hardenability is inhibited, thereby sufficiently improve the strength during paint-baking.

After the solution treatment, a stabilizing treatment may be performed as needed. Specifically, in cases in which paint-baking hardenability (BH performance) is more emphasized than the formability, it is more preferable that, after the solution treatment, cooling (quenching) is performed at a cooling rate of 100° C./min or higher in a temperature range of 50° C. or higher and lower than 150° C., and then, a stabilizing treatment is performed in the above temperature range (50 to lower than 150° C.) before the temperature is lowered to a temperature range (room temperature) lower than 50° C. The retention time in the temperature range of 50 to lower than 150° C. in the stabilizing treatment is not particularly restricted. Normally, the retention time is desirably one hour or longer, and cooling (slow cooling) may be performed in the temperature range for one hour or longer.

On the other hand, in cases in which the formability, in particular, the press formability is more emphasized than the paint-baking hardenability, cooling is performed in a temperature range of 50° C. or lower in a cooling process after the solution treatment without a stabilizing treatment, and the sheet is preferably left to stand still in a temperature range of 0 to 50° C.

The present disclosure is not limited to the above-described Embodiments, and a variety of modifications and applications are possible.

### EXAMPLES

In the following, Examples are described together with Comparative Examples. The following Examples are for describing the effect of the disclosure, and the processes and conditions described in the Examples should not be construed as a limitation of the technical scope of the disclosure.

First, alloy signs A to F and M to Q each having the component composition listed on Table 1 to be used as a material of a core material or a surface material, and alloy signs G to L and R to V to be used in Comparative Examples, and alloy signs 3 to 5, 7 to 29, 31 to 57 to be used as a material of an insert material, and alloy signs 1, 2, 6, and 30 of Comparative Example of the insert material listed on Tables 2-3 are manufactured in accordance with a conventional method, and subjected to casting into a slab by a DC casting. In Table 1, an alloy having a component composition which departs from the scope of the present disclosure is indicated as “Comparative Example”. In Table 2, an insert material having a solidus temperature which departs from the scope of the present disclosure is indicated as “Comparative Example”.

TABLE 1

| | Alloy | Alloy component composition of core material•surface material (unit: mass %) | | | | | | | | | | | |
|---|---|---|---|---|---|---|---|---|---|---|---|---|---|
| Category | sign | Mg | Si | Cu | Fe | Mn | Cr | Zn | Zr | V | Ti | Al | Note |
| Core material | A | 0.21 | 0.20 | 0.98 | 0.21 | 0.13 | — | — | — | — | 0.01 | Balance | |
| alloy | B-1 | 0.41 | 1.05 | 0.71 | 0.02 | — | — | — | — | — | — | Balance | |
| (example of | B-2 | 0.41 | 1.05 | 0.71 | 0.50 | — | — | — | — | — | — | Balance | |
| the present | B-3 | 0.41 | 1.05 | 0.71 | 0.93 | — | — | — | — | — | — | Balance | |
| disclosure) | B-4 | 0.41 | 1.05 | 0.71 | 0.02 | 0.40 | — | — | — | — | — | Balance | |
| | B-5 | 0.41 | 1.05 | 0.71 | 0.02 | — | 0.20 | — | — | — | — | Balance | |
| | B-6 | 0.41 | 1.05 | 0.71 | 0.02 | — | — | 0.01 | — | — | — | Balance | |
| | B-7 | 0.41 | 1.05 | 0.71 | 0.02 | — | — | 1.00 | — | — | — | Balance | |
| | B-8 | 0.41 | 1.05 | 0.71 | 0.02 | — | — | — | 0.20 | — | — | Balance | |
| | B-9 | 0.41 | 1.05 | 0.71 | 0.02 | — | — | — | — | 0.20 | — | Balance | |
| | B-10 | 0.41 | 1.05 | 0.71 | 0.02 | — | — | — | — | — | 0.15 | Balance | |
| | C | 0.54 | 0.92 | 1.78 | 0.09 | 0.06 | 0.03 | — | — | — | 0.02 | Balance | |
| | D | 0.72 | 1.66 | 1.33 | 0.24 | 0.24 | — | 0.52 | 0.05 | 0.03 | 0.02 | Balance | |
| | E | 0.71 | 2.38 | 1.32 | 0.25 | 0.91 | — | — | — | — | — | Balance | |
| | F | 1.26 | 0.68 | 0.21 | 0.23 | 0.05 | 0.20 | — | — | — | 0.01 | Balance | |
| Core material | G | 1.66 | 0.70 | 0.20 | 0.22 | 0.05 | 0.21 | — | — | — | 0.01 | Balance | |
| alloy | H | 0.73 | 2.72 | 1.39 | 0.24 | 0.21 | | 0.51 | 0.04 | 0.03 | 0.01 | Balance | |
| (comparative | I | 0.52 | 0.89 | 3.48 | 0.10 | 0.06 | 0.03 | — | — | — | 0.02 | Balance | |
| example) | J | 1.22 | 0.71 | 0.03 | 0.20 | 0.05 | 0.19 | — | — | — | 0.01 | Balance | |
| | K | 0.11 | 0.10 | 1_00 | 0.21 | 0.11 | — | — | — | — | 0.01 | Balance | |
| | L | — | — | — | — | — | — | — | — | — | — | Balance | 99.99% Al |
| Surface | M | 0.21 | 0.22 | 0.02 | 0.18 | 0.15 | — | — | — | — | 0.01 | Balance | |
| material alloy | N-1 | 0.55 | 0.98 | 0.05 | 0.02 | — | — | — | — | — | — | Balance | |
| (example of | N-2 | 0.55 | 0.98 | 0.05 | 0.50 | — | — | — | — | — | — | Balance | |
| the present | N-3 | 0.55 | 0.98 | 0.05 | 0.02 | 0.40 | — | — | — | — | — | Balance | |
| disclosure) | N-4 | 0.55 | 0.98 | 0.05 | 0.02 | — | 0.20 | — | — | — | — | Balance | |
| | N-5 | 0.55 | 0.98 | 0.05 | 0.02 | — | — | 1.00 | — | — | — | Balance | |
| | N-6 | 0.55 | 0.98 | 0.05 | 0.02 | — | — | — | 0.20 | — | — | Balance | |
| | N-7 | 0.55 | 0.98 | 0.05 | 0.02 | — | — | — | — | 0.20 | — | Balance | |
| | N-8 | 0.55 | 0.98 | 0.05 | 0.02 | — | — | — | — | — | 0.15 | Balance | |
| | O | 0.69 | 0.75 | 0.01 | 0.12 | 0.05 | 0.03 | 0.02 | — | 0.01 | 0.01 | Balance | |
| | P | 0.71 | 1.65 | 0.08 | 0.16 | 0.05 | 0.05 | — | — | — | 0.02 | Balance | |
| | Q | 1 22 | 0.71 | 0.03 | 0.20 | 0.03 | 0.19 | — | — | — | 0.01 | Balance | |
| Surface | R | 1.65 | 0.70 | 0.02 | 0.20 | 0.01 | 0.20 | — | — | — | 0.01 | Balance | |
| material alloy | S | 0.70 | 2.30 | 0.06 | 0.18 | 0.04 | 0.05 | — | — | — | 0.01 | Balance | |
| (comparative | T | 1.25 | 0.68 | 0.19 | 0.23 | — | 0.07 | — | — | — | 0.01 | Balance | |
| example) | U | 0.11 | 0.12 | 0.03 | 0.21 | 0.13 | — | — | — | — | 0.01 | Balance | |
| | V | — | — | — | — | — | — | — | — | — | — | Balance | 99.99% Al |

TABLE 2

| Alloy | Alloy component composition of insert material (unit: mass %) | | | | | | | | | |
|---|---|---|---|---|---|---|---|---|---|---|
| sign | Si | Cu | Mg | Others | | | | | Al | Note |
| 1 | — | 0.99 | — | | | | | | Balance | Comparative |
| | | | | | | | | | | Example |
| 2 | — | 2.01 | — | Ni: 0.02 | Sn: 0.01 | | | | Balance | Comparative |
| | | | | | | | | | | Example |
| 3 | — | 2.52 | — | Ni: 0.02 | Sn: 0.01 | | | | Balance | |
| 4 | — | 4.97 | — | Cr: 0.98 | | | | | Balance | |
| 5 | — | 9.00 | — | | | | | | Balance | |
| 6 | 0.10 | — | — | | | | | | Balance | Comparative |
| | | | | | | | | | | Example |
| 7 | 0.11 | 1.61 | — | Zn: 0.99 | Ni: 0.97 | Fe: 0.25 | Sn: 0.10 | Ti: 0.01 | Balance | |
| 8 | 0.25 | — | — | Sn: 0.92 | Zn: 0.51 | Ni: 0.05 | | | Balance | |
| 9 | 0.61 | 2.01 | — | | | | | | Balance | |
| 10 | 0.62 | 3.48 | — | | | | | | Balance | |
| 11 | 0.60 | 4.99 | — | | | | | | Balance | |
| 12 | 0.59 | 8.97 | — | | | | | | Balance | |
| 13 | 1.01 | 2.02 | — | Zn: 7.51 | | | | | Balance | |
| 14 | 1.53 | — | — | | | | | | Balance | |
| 15 | 2.02 | — | — | Zr: 0.13 | | | | | Balance | |
| 16 | 2.02 | 2.01 | — | | | | | | Balance | |
| 17 | 1.98 | 3.47 | — | | | | | | Balance | |
| 18 | 1.99 | 4.98 | — | Mn: 1.47 | Fe: 1.20 | | | | Balance | |
| 19 | 2.02 | 9.03 | — | | | | | | Balance | |
| 20 | 3.80 | — | — | Ti: 0.03 | B: 0.01 | | | | Balance | |
| 21 | 3.81 | 2.03 | — | | | | | | Balance | |
| 22 | 3.78 | 3.51 | — | | | | | | Balance | |
| 23 | 3.80 | 5.01 | — | | | | | | Balance | |
| 24 | 3.80 | 8.99 | — | | | | | | Balance | |
| 25 | 12.01 | — | — | | | | | | Balance | |
| 26 | 12.00 | 1.99 | — | | | | | | Balance | |
| 27 | 11.98 | 3.47 | — | | | | | | Balance | |
| 28 | 11.99 | 4.99 | — | | | | | | Balance | |
| 29 | 12.03 | 9.01 | — | | | | | | Balance | |
| 30 | — | — | 1.99 | | | | | | Balance | Comparative |
| | | | | | | | | | | Example |

TABLE 3

| Alloy | Alloy component composition of insert material (unit: mass %) | | | | | | | | |
|---|---|---|---|---|---|---|---|---|---|
| sign | Si | Cu | Mg | Others | | | | Al | Note |
| 31 | — | 0.02 | 1.99 | V: 0.80 | Zn: 0.41 | Sn: 0.37 | Ni: 0.37 | Balance | |
| 32 | — | 0.81 | 1.98 | Cr: 0.88 | Zn: 0.68 | Ni: 0.50 | | Balance | |
| 33 | — | 2.01 | 1.99 | | | | | Balance | |
| 34 | — | 3.03 | 1.95 | | | | | Balance | |
| 35 | — | 4.99 | 1.96 | | | | | Balance | |
| 36 | — | 9.00 | 1.54 | | | | | Balance | |
| 37 | 0.02 | — | 1.99 | Ni: 0.89 | Sn: 0.22 | Cr: 0.05 | | Balance | |
| 38 | 0.51 | — | 1.52 | Zn: 1.00 | | | | Balance | |
| 39 | 0.49 | 1.48 | 0.98 | Mn: 0.12 | Fe: 0.10 | | | Balance | |
| 40 | 0.98 | — | 1.52 | Ti: 0.11 | Zn: 0.01 | | | Balance | |
| 41 | 0.97 | 1.50 | 1.53 | Sn: 6.43 | | | | Balance | |
| 42 | 1.01 | 3.02 | 0.51 | | | | | Balance | |
| 43 | 2.01 | — | 1.99 | | | | | Balance | |
| 44 | 1.99 | 1.54 | 0.98 | | | | | Balance | |
| 45 | 1.99 | 3.01 | 0.05 | | | | | Balance | |
| 46 | 2.00 | 4.99 | 0.47 | Fe: 0.15 | Ti: 0.01 | | | Balance | |
| 47 | 2.02 | 8.98 | 0.52 | | | | | Balance | |
| 48 | 3.81 | — | 1.53 | Fe: 0.28 | Cr: 0.03 | Ni: 0.01 | | Balance | |
| 49 | 3.82 | 1.50 | 1.04 | | | | | Balance | |
| 50 | 3.80 | 2.98 | 0.05 | | | | | Balance | |
| 51 | 3.81 | 5.01 | 0.51 | | | | | Balance | |
| 52 | 3.80 | 9.01 | 0.06 | | | | | Balance | |
| 53 | 12.05 | — | 1.02 | | | | | Balance | |
| 54 | 12.04 | 1.47 | 1.03 | | | | | Balance | |
| 55 | 11.99 | 2.98 | 1.00 | | | | | Balance | |
| 56 | 12.01 | 5.03 | 0.50 | | | | | Balance | |
| 57 | 12.02 | 9.01 | 2.00 | | | | | Balance | |

Next, the core material was subjected to machine cutting, the surface material was subjected to hot rolling, and the insert material was subjected to hot rolling and cold rolling such that cladding ratios, and the thickness of the insert material and the ratio of the sheet thickness of the insert material during a high-temperature heat treatment are as listed on Tables 4 to 7, and then the core material, the surface material, and the insert material were layered according to the combinations listed on Tables 4 to 7 such that the insert material was between the core material and the surface material. Among the manufacturing signs 001 to 119, and 125 to 144 in which clad rolling was performed, for manufacturing signs 015, 034 to 037, 064 to 067, 076, 077, 113, and 134, the surface material and the insert material were layered on both sides of the core material (both sides clad), for other manufacturing signs, the surface material and the insert material were layered only on one side (one side clad). The cladding ratio and the ratio of the sheet thickness of the insert material listed on Tables 4 to 7 indicate values on one side for both of the both sides cladding material, and the one side cladding material.

TABLE 4

| | | | | | Insert material | | | | High- |
|---|---|---|---|---|---|---|---|---|---|
| | | Core | Surface | | | Thickness/ | | Solidus | temperature |
| Manufacturing | | material | material | Cladding | Thickness | Total sheet | Alloy | temperature | heat treatment |
| sign | Category | alloy sign | alloy sign | ratio (%) | (μm) | thickness (%) | sign | (° C.) | (° C.) |
| 001 | Example | A | M | 10 | 200 | 0.36 | 3 | 590 | 590 |
| 002 | of the | A | M | 10 | 200 | 0.36 | 4 | 550 | 570 |
| 003 | present | A | M | 10 | 200 | 0.36 | 5 | 550 | 550 |
| 004 | disclosure | A | M | 10 | 200 | 0.36 | 7 | 590 | 590 |
| 005 | | A | M | 10 | 200 | 0.36 | 31 | 590 | 590 |
| 006 | | A | M | 10 | 200 | 0.36 | 32 | 590 | 590 |
| 007 | | A | M | 10 | 200 | 0.36 | 37 | 590 | 590 |
| 008 | | A | M | 10 | 200 | 0.36 | 38 | 590 | 590 |
| 009 | | A | N-1 | 10 | 200 | 0.36 | 9 | 580 | 585 |
| 010 | | A | O | 10 | 200 | 0.36 | 14 | 580 | 580 |
| 011 | | A | P | 10 | 200 | 0.36 | 11 | 540 | 560 |
| 012 | | A | Q | 10 | 200 | 0.36 | 8 | 575 | 580 |
| 013 | | B-1 | M | 10 | 200 | 0.36 | 10 | 560 | 565 |
| 014 | | B-1 | N-1 | 10 | 200 | 0.36 | 12 | 540 | 570 |
| 015 | | B-1 | N-1 | 10 | 200 | 0.32 | 12 | 540 | 570 |
| 016 | | B-1 | N-1 | 10 | 200 | 0.36 | 12 | 540 | 570 |
| 017 | | B-1 | N-1 | 10 | 200 | 0.36 | 12 | 540 | 570 |
| 018 | | B-1 | N-2 | 10 | 200 | 0.36 | 12 | 540 | 570 |
| 019 | | B-1 | N-3 | 10 | 200 | 0.36 | 12 | 540 | 570 |
| 020 | | B-1 | N-4 | 10 | 200 | 0.36 | 12 | 540 | 570 |
| 021 | | B-1 | N-5 | 10 | 200 | 0.36 | 12 | 540 | 570 |
| 022 | | B-1 | N-6 | 10 | 200 | 0.36 | 12 | 540 | 570 |
| 023 | | B-1 | N-7 | 10 | 200 | 0.36 | 12 | 540 | 570 |
| 024 | | B-1 | N-8 | 10 | 200 | 0.36 | 12 | 540 | 570 |
| 025 | | B-1 | O | 4 | 10 | 0.02 | 13 | 570 | 570 |
| 026 | | B-1 | O | 4 | 50 | 0.10 | 13 | 570 | 570 |
| 027 | | B-1 | O | 4 | 100 | 0.19 | 13 | 570 | 570 |
| 028 | | B-1 | O | 4 | 200 | 0.38 | 13 | 570 | 570 |
| 029 | | B-1 | O | 4 | 400 | 0.76 | 13 | 570 | 570 |
| 030 | | B-1 | O | 4 | 600 | 1.14 | 13 | 570 | 570 |
| 031 | | B-1 | O | 10 | 200 | 0.36 | 13 | 570 | 570 |
| 032 | | B-1 | O | 20 | 200 | 0.32 | 13 | 570 | 570 |
| 033 | | B-1 | O | 25 | 200 | 0.30 | 13 | 570 | 570 |
| 034 | | B-1 | O | 4 | 200 | 0.36 | 13 | 570 | 570 |
| 035 | | B-1 | O | 10 | 200 | 0.32 | 13 | 570 | 570 |
| 036 | | B-1 | O | 20 | 200 | 0.24 | 13 | 570 | 570 |
| 037 | | B-1 | O | 25 | 200 | 0.20 | 13 | 570 | 570 |
| 038 | | B-1 | O | 10 | 200 | 0.36 | 16 | 555 | 565 |
| 039 | | B-1 | O | 10 | 200 | 0.36 | 18 | 530 | 540 |
| 040 | | B-1 | O | 10 | 200 | 0.36 | 33 | 570 | 570 |
| 041 | | B-1 | O | 10 | 200 | 0.36 | 23 | 530 | 560 |
| 042 | | B-1 | O | 10 | 200 | 0.36 | 43 | 565 | 565 |
| 043 | | B-2 | O | 10 | 200 | 0.36 | 43 | 565 | 565 |
| 044 | | B-3 | O | 10 | 200 | 0.36 | 43 | 565 | 565 |
| 045 | | B-4 | O | 10 | 200 | 0.36 | 43 | 565 | 565 |
| 046 | | B-5 | O | 10 | 200 | 0-36 | 43 | 565 | 565 |
| 047 | | B-6 | O | 10 | 200 | 0.36 | 43 | 565 | 565 |
| 048 | | B-7 | O | 10 | 200 | 0.36 | 43 | 565 | 565 |
| 049 | | B-8 | O | 10 | 200 | 0.36 | 43 | 565 | 565 |
| 050 | | B-9 | O | 10 | 200 | 0.36 | 43 | 565 | 565 |
| 051 | | B-10 | O | 10 | 200 | 0.36 | 43 | 565 | 565 |
| 052 | | B-1 | P | 10 | 200 | 0.36 | 29 | 525 | 525 |
| 053 | | B-1 | Q | 10 | 200 | 0.36 | 34 | 540 | 560 |

| | 0.2% proof | | | 0.2% proof | | Surface | |
|---|---|---|---|---|---|---|---|
| | stress before | Pre-bake | | stress after | | hardness | |
| Manufacturing | paint-baking | elongation | Hemming | paint-baking | Corrosion | after paint- | |
| sign | (MPa) | (%) | workability | (MPa) | resistance | baking Hv | Note |
| 001 | 80 | 29 | ⊚ | 131 | ◯ | 28 | |
| 002 | 80 | 29 | ⊚ | 131 | ◯ | 28 | |
| 003 | 80 | 29 | ⊚ | 132 | ◯ | 30 | |
| 004 | 81 | 29 | ⊚ | 131 | ◯ | 28 | |
| 005 | 80 | 29 | ⊚ | 132 | ◯ | 30 | |
| 006 | 80 | 29 | ⊚ | 131 | ◯ | 28 | |
| 007 | 81 | 29 | ⊚ | 131 | ◯ | 28 | |
| 008 | 80 | 29 | ⊚ | 132 | ◯ | 28 | |
| 009 | 82 | 29 | ⊚ | 137 | ◯ | 61 | |
| 010 | 83 | 29 | ⊚ | 137 | ◯ | 61 | |
| 011 | 84 | 29 | ◯ | 138 | ◯ | 64 | |
| 012 | 83 | 29 | ◯ | 135 | ◯ | 57 | |
| 013 | 104 | 30 | ⊚ | 200 | ◯ | 28 | |
| 014 | 107 | 30 | ⊚ | 206 | ◯ | 61 | |
| 015 | 107 | 30 | ⊚ | 206 | ◯ | 60 | Both sides clad |
| 016 | 108 | 30 | ⊚ | 207 | ◯ | 61 | High-temper- |
| | | | | | | | ature heating |
| | | | | | | | under nitrogen |
| | | | | | | | atmosphere, |
| | | | | | | | maximum |
| | | | | | | | rolling |
| | | | | | | | reduction ratio |
| | | | | | | | of one pass |
| | | | | | | | 55% |
| 017 | 107 | 30 | ⊚ | 205 | ◯ | 60 | High-temper- |
| | | | | | | | ature heating |
| | | | | | | | under vacuum, |
| | | | | | | | maximum |
| | | | | | | | rolling |
| | | | | | | | reduction ratio |
| | | | | | | | of one pass |
| | | | | | | | 55% |
| 018 | 107 | 30 | ⊚ | 207 | ◯ | 63 | |
| 019 | 108 | 30 | ⊚ | 207 | ◯ | 63 | |
| 020 | 108 | 30 | ⊚ | 206 | ◯ | 62 | |
| 021 | 107 | 30 | ⊚ | 207 | ◯ | 63 | |
| 022 | 108 | 30 | ⊚ | 206 | ◯ | 62 | |
| 023 | 107 | 30 | ⊚ | 207 | ◯ | 62 | |
| 024 | 107 | 30 | ⊚ | 206 | ◯ | 62 | |
| 025 | 107 | 30 | ⊚ | 206 | ◯ | 61 | |
| 026 | 107 | 30 | ⊚ | 206 | ◯ | 61 | |
| 027 | 108 | 30 | ⊚ | 207 | ◯ | 60 | |
| 028 | 107 | 30 | ⊚ | 206 | ◯ | 61 | |
| 029 | 108 | 30 | ⊚ | 207 | ◯ | 60 | |
| 030 | 108 | 29 | ◯ | 207 | ◯ | 60 | Thickness/total |
| | | | | | | | sheet |
| | | | | | | | thickness of |
| | | | | | | | insert material |
| | | | | | | | 1% or higher |
| 031 | 107 | 30 | ⊚ | 206 | ◯ | 61 | |
| 032 | 107 | 30 | ⊚ | 206 | ◯ | 60 | |
| 033 | 107 | 30 | ⊚ | 206 | ◯ | 61 | |
| 034 | 107 | 30 | ⊚ | 206 | ◯ | 61 | Both sides clad |
| 035 | 108 | 30 | ⊚ | 206 | ◯ | 60 | Both sides clad |
| 036 | 106 | 30 | ⊚ | 205 | ◯ | 61 | Both sides clad |
| 037 | 106 | 30 | ⊚ | 205 | ◯ | 61 | Both sides clad |
| 038 | 107 | 30 | ⊚ | 206 | ◯ | 60 | |
| 039 | 108 | 30 | ⊚ | 207 | ◯ | 61 | |
| 040 | 108 | 30 | □ | 207 | ◯ | 61 | |
| 041 | 107 | 30 | ⊚ | 206 | ◯ | 60 | |
| 042 | 108 | 30 | ⊚ | 207 | ◯ | 61 | |
| 043 | 110 | 30 | ⊚ | 211 | ◯ | 61 | |
| 044 | 110 | 30 | ⊚ | 212 | ◯ | 61 | |
| 045 | 111 | 30 | ⊚ | 210 | ◯ | 60 | |
| 046 | 110 | 30 | □ | 209 | ◯ | 61 | |
| 047 | 108 | 30 | ⊚ | 208 | ◯ | 61 | |
| 048 | 110 | 30 | ⊚ | 214 | ◯ | 61 | |
| 049 | 110 | 30 | ⊚ | 209 | ◯ | 61 | |
| 050 | 110 | 30 | ⊚ | 209 | ◯ | 61 | |
| 051 | 109 | 30 | ⊚ | 207 | ◯ | 60 | |
| 052 | 108 | 30 | ◯ | 207 | ◯ | 64 | |
| 053 | 107 | 30 | ◯ | 205 | ◯ | 57 | |

TABLE 5

| | | | | | Insert material | | | | High- |
|---|---|---|---|---|---|---|---|---|---|
| | | Core | Surface | | | Thickness/ | | Solidus | temperature |
| Manufacturing | | material | material | Cladding | Thickness | Total sheet | Alloy | temperature | heat treatment |
| sign | Category | alloy sign | alloy sign | ratio (%) | (μm) | thickness (%) | sign | (° C.) | (° C.) |
| 054 | Example | C | M | 10 | 200 | 0.36 | 17 | 540 | 550 |
| 055 | of the | C | N-1 | 4 | 200 | 0.38 | 35 | 515 | 530 |
| 056 | present | C | N-1 | 10 | 10 | 0.20 | 35 | 515 | 530 |
| 057 | disclosure | C | N-1 | 10 | 50 | 0.09 | 35 | 515 | 530 |
| 058 | | C | N-1 | 10 | 100 | 0.18 | 35 | 515 | 530 |
| 059 | | C | N-1 | 10 | 200 | 0.36 | 35 | 515 | 530 |
| 060 | | C | N-1 | 10 | 400 | 0.72 | 35 | 515 | 530 |
| 061 | | C | N-1 | 10 | 600 | 1.07 | 35 | 515 | 530 |
| 062 | | C | N-1 | 20 | 200 | 0.24 | 35 | 515 | 530 |
| 063 | | C | N-1 | 25 | 200 | 0.20 | 35 | 515 | 530 |
| 064 | | C | N-1 | 4 | 10 | 0.02 | 35 | 515 | 530 |
| 065 | | C | N-1 | 10 | 10 | 0.02 | 35 | 515 | 530 |
| 066 | | C | N-1 | 20 | 10 | 0.01 | 35 | 515 | 530 |
| 067 | | C | N-1 | 25 | 10 | 0.01 | 35 | 515 | 530 |
| 068 | | C | N-2 | 10 | 200 | 0.36 | 35 | 515 | 530 |
| 069 | | C | N-3 | 10 | 200 | 0.36 | 35 | 515 | 530 |
| 070 | | C | N-4 | 10 | 200 | 0.36 | 35 | 515 | 530 |
| 071 | | C | N-5 | 10 | 200 | 0.36 | 35 | 515 | 530 |
| 072 | | C | N-6 | 10 | 200 | 0.36 | 35 | 515 | 530 |
| 073 | | C | N-7 | 10 | 200 | 0.36 | 35 | 515 | 530 |
| 074 | | C | N-8 | 10 | 200 | 0.36 | 35 | 515 | 530 |
| 075 | | C | O | 10 | 200 | 0.36 | 36 | 510 | 515 |
| 076 | | C | O | 10 | 200 | 0.32 | 36 | 510 | 515 |
| 077 | | C | O | 10 | 200 | 0.32 | 22 | 540 | 540 |
| 078 | | C | O | 10 | 200 | 0.32 | 36 | 510 | 515 |
| 079 | | C | O | 10 | 200 | 0.32 | 36 | 510 | 515 |
| 080 | | C | P | 10 | 200 | 0.36 | 19 | 530 | 610 |
| 081 | | C | P | 10 | 200 | 0.36 | 48 | 550 | 550 |
| 082 | | C | P | 10 | 200 | 0.36 | 19 | 530 | 550 |
| 083 | | C | P | 10 | 200 | 0.36 | 24 | 530 | 540 |
| 084 | | C | P | 10 | 200 | 0.36 | 27 | 535 | 540 |
| 085 | | C | P | 10 | 200 | 0.36 | 28 | 530 | 530 |
| 086 | | C | P | 10 | 200 | 0.36 | 42 | 530 | 550 |
| 087 | | C | Q | 10 | 200 | 0.36 | 44 | 540 | 540 |
| 088 | | D | M | 10 | 200 | 0.36 | 45 | 540 | 540 |
| 089 | | D | N-1 | 10 | 200 | 0.36 | 46 | 510 | 520 |
| 090 | | D | O | 10 | 200 | 0.36 | 47 | 510 | 530 |
| 091 | | D | P | 10 | 200 | 0.36 | 49 | 540 | 540 |
| 092 | | D | P | 10 | 200 | 0.36 | 50 | 540 | 540 |
| 093 | | D | P | 10 | 200 | 0.36 | 51 | 510 | 540 |
| 094 | | D | P | 10 | 200 | 0.36 | 52 | 520 | 520 |
| 095 | | D | P | 10 | 200 | 0.36 | 54 | 540 | 540 |
| 096 | | D | P | 10 | 200 | 0.36 | 55 | 525 | 530 |
| 097 | | D | P | 4 | 200 | 0.38 | 56 | 510 | 530 |
| 098 | | D | P | 10 | 200 | 0.36 | 56 | 510 | 530 |
| 099 | | D | P | 20 | 10 | 0.02 | 56 | 510 | 530 |
| 100 | | D | P | 20 | 50 | 0.08 | 56 | 510 | 530 |
| 101 | | D | P | 20 | 100 | 0.16 | 56 | 510 | 530 |
| 102 | | D | P | 20 | 200 | 0.32 | 56 | 510 | 530 |
| 103 | | D | P | 20 | 400 | 0.64 | 56 | 510 | 530 |
| 104 | | D | P | 20 | 600 | 0.95 | 56 | 510 | 530 |
| 105 | | D | P | 25 | 200 | 0.30 | 56 | 510 | 530 |
| 106 | | D | Q | 10 | 200 | 0.36 | 57 | 510 | 520 |

| | 0.2% proof | | | 0.2% proof | | Surface | |
|---|---|---|---|---|---|---|---|
| | stress before | Pre-bake | | stress after | | hardness | |
| Manufacturing | paint-baking | elongation | Hemming | paint-baking | Corrosion | after paint- | |
| sign | (MPa) | (%) | workability | (MPa) | resistance | baking Hv | Note |
| 054 | 129 | 30 | ⊚ | 230 | ◯ | 28 | |
| 055 | 133 | 30 | ⊚ | 237 | ◯ | 61 | |
| 056 | 132 | 30 | ⊚ | 236 | ◯ | 60 | |
| 057 | 132 | 30 | ⊚ | 236 | ◯ | 61 | |
| 058 | 131 | 30 | ⊚ | 236 | ◯ | 60 | |
| 059 | 132 | 30 | ⊚ | 236 | ◯ | 61 | |
| 060 | 131 | 30 | ⊚ | 235 | ◯ | 61 | |
| 061 | 132 | 29 | ◯ | 236 | ◯ | 61 | Thickness/total |
| | | | | | | | sheet thickness of |
| | | | | | | | insert material |
| | | | | | | | 1% or higher |
| 062 | 131 | 30 | ⊚ | 235 | ◯ | 61 | |
| 063 | 130 | 30 | ⊚ | 234 | ◯ | 60 | |
| 064 | 132 | 30 | ⊚ | 236 | ◯ | 61 | Both sides clad |
| 065 | 131 | 30 | ⊚ | 235 | ◯ | 61 | Both sides clad |
| 066 | 128 | 29 | ⊚ | 231 | ◯ | 60 | Both sides clad |
| 067 | 125 | 29 | ⊚ | 228 | ◯ | 61 | Both sides clad |
| 068 | 132 | 30 | ⊚ | 236 | ◯ | 63 | |
| 069 | 132 | 30 | ⊚ | 236 | ◯ | 63 | |
| 070 | 133 | 30 | ⊚ | 237 | ◯ | 62 | |
| 071 | 131 | 30 | ⊚ | 236 | ◯ | 63 | |
| 072 | 132 | 30 | ⊚ | 237 | ◯ | 62 | |
| 073 | 132 | 30 | ⊚ | 236 | ◯ | 62 | |
| 074 | 132 | 30 | ⊚ | 236 | ◯ | 62 | |
| 075 | 132 | 30 | ⊚ | 236 | ◯ | 61 | |
| 076 | 131 | 30 | ⊚ | 235 | ◯ | 60 | Both sides clad |
| 077 | 131 | 30 | ⊚ | 235 | ◯ | 61 | Both sides clad |
| 078 | 132 | 30 | ⊚ | 236 | ◯ | 61 | High-temperature |
| | | | | | | | heating under |
| | | | | | | | nitrogen |
| | | | | | | | atmosphere, |
| | | | | | | | maximum rolling |
| | | | | | | | reduction ratio of |
| | | | | | | | one pass 55% |
| 079 | 133 | 30 | ⊚ | 236 | ◯ | 61 | High-temperature |
| | | | | | | | heating under |
| | | | | | | | vacuum, |
| | | | | | | | maximum rolling |
| | | | | | | | reduction ratio of |
| | | | | | | | one pass 55% |
| 080 | 134 | 28 | ◯ | 236 | ◯ | 64 | High-temperature |
| | | | | | | | heating at a high |
| | | | | | | | temperature |
| | | | | | | | above favorable |
| | | | | | | | temperature |
| | | | | | | | range |
| 081 | 133 | 30 | ◯ | 237 | ◯ | 64 | |
| 082 | 134 | 30 | ◯ | 237 | ◯ | 64 | |
| 083 | 134 | 30 | ◯ | 238 | ◯ | 65 | |
| 084 | 133 | 30 | ◯ | 238 | ◯ | 65 | |
| 085 | 134 | 30 | ◯ | 237 | ◯ | 64 | |
| 086 | 133 | 30 | ◯ | 238 | ◯ | 64 | |
| 087 | 132 | 30 | ◯ | 234 | ◯ | 57 | |
| 088 | 131 | 30 | ⊚ | 231 | ◯ | 29 | |
| 089 | 134 | 30 | ⊚ | 238 | ◯ | 61 | |
| 090 | 134 | 30 | ⊚ | 237 | ◯ | 61 | |
| 091 | 135 | 30 | ◯ | 239 | ◯ | 65 | |
| 092 | 135 | 30 | ◯ | 238 | ◯ | 64 | |
| 093 | 135 | 30 | ◯ | 239 | ◯ | 65 | |
| 094 | 136 | 30 | ◯ | 239 | ◯ | 65 | |
| 095 | 134 | 30 | ◯ | 238 | ◯ | 64 | |
| 096 | 135 | 30 | ◯ | 239 | ◯ | 64 | |
| 097 | 136 | 30 | ◯ | 240 | ◯ | 65 | |
| 098 | 135 | 30 | ◯ | 239 | ◯ | 64 | |
| 099 | 134 | 30 | ◯ | 237 | ◯ | 64 | |
| 100 | 134 | 30 | ◯ | 236 | ◯ | 65 | |
| 101 | 133 | 30 | ◯ | 238 | ◯ | 64 | |
| 102 | 134 | 30 | ◯ | 237 | ◯ | 65 | |
| 103 | 134 | 30 | ◯ | 237 | ◯ | 64 | |
| 104 | 134 | 30 | ◯ | 236 | ◯ | 65 | |
| 105 | 133 | 30 | ◯ | 236 | ◯ | 64 | |
| 106 | 134 | 30 | ◯ | 236 | ◯ | 57 | |

TABLE 6

| | | | | | Insert material | | | | High- |
|---|---|---|---|---|---|---|---|---|---|
| | | Core | Surface | | | Thickness/ | | Solidus | temperature |
| Manufacturing | | material | material | Cladding | Thickness | Total sheet | Alloy | temperature | heat treatment |
| sign | Category | alloy sign | alloy sign | ratio (%) | (μm) | thickness (%) | sign | (° C.) | (° C.) |
| 107 | Example | E | M | 10 | 200 | 0.36 | 19 | 530 | 530 |
| 108 | of the | E | N-1 | 10 | 200 | 0.36 | 51 | 510 | 530 |
| 109 | present | F | M | 10 | 200 | 0.36 | 15 | 580 | 580 |
| 110 | disclosur | F | N-1 | 10 | 200 | 0.36 | 10 | 560 | 570 |
| 111 | | F | 0 | 10 | 200 | 0.36 | 20 | 580 | 580 |
| 112 | | F | P | 10 | 200 | 0.36 | 41 | 555 | 560 |
| 113 | | F | P | 10 | 200 | 0.32 | 41 | 555 | 560 |
| 114 | Example | F | Q | 10 | 200 | 0.36 | 39 | 570 | 570 |
| 115 | of the | F | Q | 10 | 200 | 0.36 | 40 | 575 | 575 |
| 116 | present | F | Q | 10 | 200 | 0.36 | 53 | 555 | 570 |
| 117 | disclosure | F | Q | 10 | 200 | 0.36 | 25 | 580 | 580 |
| 118 | | F | Q | 10 | 200 | 0.36 | 26 | 555 | 570 |
| 119 | | F | Q | 10 | 200 | 0.36 | 21 | 555 | 560 |

| | 0.2% proof | | | 0.2% proof | | Surface | |
|---|---|---|---|---|---|---|---|
| | stress before | Pre-bake | | stress after | | hardness | |
| Manufacturing | paint-baking | elongation | Hemming | paint-baking | Corrosion | after paint- | |
| sign | (MPa) | (%) | workability | (MPa) | resistance | baking Hv | Note |
| 107 | 144 | 29 | ⊚ | 241 | ◯ | 30 | |
| 108 | 145 | 29 | ⊚ | 242 | ◯ | 60 | |
| 109 | 112 | 29 | ⊚ | 197 | ◯ | 29 | |
| 110 | 114 | 29 | ⊚ | 204 | ◯ | 61 | |
| 111 | 114 | 29 | ⊚ | 203 | ◯ | 60 | |
| 112 | 115 | 29 | ◯ | 205 | ◯ | 64 | |
| 113 | 115 | 29 | ◯ | 206 | ◯ | 64 | Both sides clad |
| 114 | 115 | 29 | ◯ | 203 | ◯ | 57 | |
| 115 | 114 | 29 | ◯ | 202 | ◯ | 58 | |
| 116 | 114 | 29 | ◯ | 202 | ◯ | 57 | |
| 117 | 115 | 29 | ◯ | 203 | ◯ | 58 | |
| 118 | 114 | 29 | ◯ | 202 | ◯ | 57 | |
| 119 | 114 | 29 | ◯ | 202 | ◯ | 57 | |

TABLE 7

| | | | | | Insert material | | | | High- |
|---|---|---|---|---|---|---|---|---|---|
| | | Core | Surface | | | Thickness/ | | Solidus | temperature |
| Manufacturing | | material | material | Cladding | Thickness | Total sheet | Alloy | temperature | heat treatment |
| sign | Category | alloy sign | alloy sign | ratio (%) | (μm) | thickness (%) | sign | (° C.) | (°C) |
| 120 | Comparative | A | — | — | — | — | — | — | 540 |
| 121 | Example | B-1 | — | — | — | — | — | — | 540 |
| 122 | | C | — | — | — | — | — | — | 540 |
| 123 | | N-1 | — | — | — | — | — | — | 540 |
| 124 | | O | | — | — | — | — | — | 540 |
| 125 | | B-1 | O | 10 | — | — | — | — | 560 |
| 126 | | C | O | 10 | — | — | — | — | 540 |
| 127 | | C | O | 10 | 200 | 0.36 | 36 | 510 | 500 |
| 128 | | C | O | 10 | 200 | 0.36 | 42 | 530 | 525 |
| 129 | | A | M | 10 | 200 | 0.36 | 1 | >590 | 590 |
| 130 | | A | M | 10 | 200 | 0.36 | 2 | >590 | 590 |
| 131 | | A | M | 10 | 200 | 0.36 | 6 | >590 | 590 |
| 132 | | A | M | 10 | 200 | 0.36 | 30 | >590 | 590 |
| 133 | | B-1 | O | 1 | 200 | 0.39 | 13 | 570 | 570 |
| 134 | | C | N-1 | 35 | 10 | 0.01 | 35 | 515 | 530 |
| 135 | | G | O | 10 | 200 | 0.36 | 20 | 580 | 580 |
| 136 | | H | O | 10 | 200 | 0.36 | 47 | 510 | 530 |
| 137 | | I | O | 10 | 200 | 0.36 | 36 | 510 | 515 |
| 138 | | J | O | 10 | 200 | 0.36 | 20 | 580 | 580 |
| 139 | | K | O | 10 | 200 | 0.36 | 14 | 580 | 580 |
| 140 | | C | R | 10 | 200 | 0.36 | 44 | 540 | 540 |
| 141 | | C | S | 10 | 200 | 0.36 | 48 | 550 | 550 |
| 142 | | C | T | 10 | 200 | 0.36 | 44 | 540 | 540 |
| 143 | | C | U | 10 | 200 | 0.36 | 17 | 540 | 550 |
| 144 | | L | V | 10 | 200 | 0.36 | 13 | 570 | 590 |

| | 0.2% proof | | | 0.2% proof | | Surface | |
|---|---|---|---|---|---|---|---|
| | stress before | Pre-bake | | stress after | | hardness | |
| Manufacturing | paint-baking | elongation | Hemming | paint-baking | Corrosion | after paint- | |
| sign | (MPa) | (%) | workability | (MPa) | resistance | baking Hv | Note |
| 120 | 80 | 29 | ⊚ | 129 | X | 38 | Example of |
| | | | | | | | single alloy |
| 121 | 107 | 30 | ◯ | 206 | X | 60 | Example of |
| | | | | | | | single alloy |
| 122 | 135 | 30 | ◯ | 239 | X | 71 | Example of |
| | | | | | | | single alloy |
| 123 | 104 | 27 | ⊚ | 208 | ◯ | 61 | Example of |
| | | | | | | | single alloy |
| 124 | 105 | 27 | ⊚ | 205 | ◯ | 61 | Example of |
| | | | | | | | single alloy |
| 125 | — | — | — | — | — | — | Normal hot |
| | | | | | | | rolled clad |
| 126 | — | — | — | — | — | — | Normal hot |
| | | | | | | | rolled clad |
| 127 | — | — | — | — | — | — | High-temperature |
| | | | | | | | heating of insert |
| | | | | | | | material below |
| | | | | | | | solidus |
| | | | | | | | temperature |
| 128 | — | — | — | — | — | — | High-temperature |
| | | | | | | | heating of insert |
| | | | | | | | material below |
| | | | | | | | solidus |
| | | | | | | | temperature |
| 129 | — | — | — | — | — | — | Out of range of |
| | | | | | | | insert material |
| | | | | | | | solidus |
| | | | | | | | temperature |
| 130 | — | — | — | — | — | — | Out of range of |
| | | | | | | | insert material |
| | | | | | | | solidus |
| | | | | | | | temperature |
| 131 | — | — | — | — | — | — | Out of range of |
| | | | | | | | insert material |
| | | | | | | | solidus |
| | | | | | | | temperature |
| 132 | — | — | — | — | — | — | Out of range of |
| | | | | | | | insert material |
| | | | | | | | solidus |
| | | | | | | | temperature |
| 133 | 107 | 30 | ◯ | 206 | X | 62 | Below lower |
| | | | | | | (reference | limit of cladding |
| | | | | | | value) | ratio |
| 134 | 115 | 29 | ⊚ | 217 | ◯ | 61 | Above upper |
| | | | | | | | limit of both |
| | | | | | | | sides clad, |
| | | | | | | | cladding ratio |
| 135 | 121 | 28 | ⊚ | 210 | ◯ | 61 | Out of range of |
| | | | | | | | core material |
| | | | | | | | composition |
| 136 | 156 | 27 | ⊚ | 256 | ◯ | 61 | Out of range of |
| 137 | 195 | 24 | ⊚ | 324 | ◯ | 60 | Out of range of |
| | | | | | | | core material |
| | | | | | | | composition |
| 138 | 109 | 27 | ⊚ | 193 | ◯ | 61 | Out of range of |
| | | | | | | | core material |
| | | | | | | | composition |
| 139 | 62 | 34 | ⊚ | 82 | ◯ | 60 | Out of range of |
| | | | | | | | core material |
| | | | | | | | composition |
| 140 | 133 | 30 | Δ | 235 | ◯ | 60 | Out of range of |
| | | | | | | | surface material |
| | | | | | | | composition |
| 141 | 134 | 30 | X | 238 | ◯ | 66 | Out of range of |
| | | | | | | | surface material |
| | | | | | | | composition |
| 142 | 133 | 30 | ⊚ | 235 | Δ | 60 | Out of range of |
| | | | | | | | surface material |
| | | | | | | | composition |
| 143 | 126 | 30 | ⊚ | 220 | ◯ | 13 | Out of range of |
| | | | | | | | hsurface material |
| | | | | | | | composition |
| 144 | — | — | — | — | — | — | Confirmation of |
| | | | | | | | bonding between |
| | | | | | | | high-purity |
| | | | | | | | aluminum and |
| | | | | | | | insert material |

Subsequently, in order to perform bonding utilizing a liquid phase of the insert material, a high-temperature heat treatment was performed at the temperatures on Tables 4 to 7 for two hours. A high-temperature heat treatment was performed, for the manufacturing signs 016, 078, under a nitrogen atmosphere which is a non-oxidizing atmosphere, for the manufacturing signs 017, 079, under vacuum which is a non-oxidizing atmosphere, and for other manufacturing signs, in the atmosphere which is an oxidizing atmosphere. After a high-temperature heat treatment, manufacturing hot rolling was performed to obtain a sheet having a thickness 3.0 mm. For the manufacturing signs 016, 017, 078, 079 on which a high-temperature heat treatment was performed under a non-oxidizing atmosphere, the maximum rolling reduction ratio of one pass was 55%; for other manufacturing signs, the maximum rolling reduction ratio of one pass was 40%. A hot rolled sheet was subjected to process annealing under conditions of 530° C. for five minutes by using a niter furnace, to forced-air cooling by a fan to room temperature, and then to cold rolling until a thickness of 1.0 mm was attained.

The obtained cold rolled sheet was subjected to a solution treatment at 530° C. for one minute by a niter furnace, to forced-air cooling by a fan to room temperature, and immediately thereafter, to a preliminary aging treatment at 80° C. for five hours to manufacture an aluminum alloy clad material (test material). In Table 7, manufacturing signs 120 to 124 are test materials of single alloy, and the manufacturing signs 120 to 126 did not use an insert material.

For each of the thus obtained test materials, a JIS 5 test piece was cut out in a direction parallel to the rolling direction, and 0.2% proof stress before paint-baking and pre-bake elongation were evaluated by tensile test. After 2% stretching, 0.2% proof stress after paint-baking on which a 170° C.×20 minute-paint-baking treatment was performed by using an oil bath was also measured.

For the sheet material after paint-baking on which a paint-baking treatment was performed in the manner as above, a Vickers hardness test was performed. The Vickers hardness test was performed in accordance with JIS Z2244. The test force was 0.015 Kgf, and the position of the hardness measurement was on the rolling surface which is the surface on the side of the surface material. Since, for the manufacturing sign 133, the thickness of the surface material which is a layer to be tested was below 1.5 times the length of the diagonal line of a depression (impression), the value is listed for reference.

For each test material obtained as mentioned above, a JIS 5 test piece was cut out in a direction parallel to the rolling direction, the piece was stretched 5%, bent 180° at a bend radius R of 0.5 mm, and evaluated by using a magnifier the existence of crack and generation of roughening (hemming workability). For one side cladding material, bending was performed such that the surface on the side of the surface material was the outside of the bending. Here, the sign “⊚” indicates that both crack and roughening were not generated, the sign “∘” indicates that crack was not generated, the sign “Δ” indicates that a crack which did not pass through the sheet thickness was generated, and the sign “x” indicates generation of a crack which passed through the sheet thickness.

Still further, a corrosion resistance (filiform corrosion resistance) was performed in the procedure below. From each of the test material obtained as mentioned above, a sheet of 70 mm in the rolling width direction and 150 mm in the rolling direction was cut out, and a rust-preventive lubricating oil RP-75N (manufactured by YUKEN KOGYO Co., Ltd.) was applied thereto at 0.5 g/m². After that, the temperature of a commercially available alkaline degreasing agent 2% FC-E2082 (manufactured by Nihon Parkerizing Co., Ltd.) was elevated to 40° C., and the pH thereof was adjusted to 11.0 by carbon dioxide gas to perform degreasing by immersing for two minutes, followed by water washing by spraying. Thereafter, a surface adjustment (20 seconds at room temperature) and a zinc phosphate (free acid 0.6 pt, total acid 26.0 pt, reaction accelerator 4.5 pt, free fluorine 175 ppm) 40° C.×2 min treatment were performed, and spray water washing and drying after pure water washing treatment was performed. Thereafter, a cationic electrodeposition coating was applied such that the coating film thickness was 15 μm and the temperature was maintained at 170° C.×20 minutes for paint-baking, and further, an intermediate coating film was applied such that the coating film thickness was 35 μm and the temperature was maintained at 140° C.×20 minutes for drying, and a 15 μm base coating film and a 35 μm clear coating film were applied thereon to form a top coating film by maintaining the temperature at 140° C.×20 minutes to manufacture a coating sheet for corrosion test. For one side cladding material, an intermediate coating film and a top coating film were formed on the surface on the surface material side.

On the surface on the surface material side of the above-mentioned coating sheet, a cross-cut scratch having 10 cm on one side reaching the aluminum base was made by a cutter, and then, the sheet was exposed to a salt spray test (5% NaCl, 35° C.) for 24 hours. After that, a cycle test of 240 hours exposure was performed four cycles by a 40° C., RH (Relative Humidity) 70% constant temperature and humidity tester to evaluate the sheet by the maximum filiform corrosion length.

The measurement of the maximum filiform corrosion length was performed by measuring the corrosion length in a direction perpendicular to the cross-cut scratch. Setting the maximum length of a filiform corrosion generated on the test piece to L (mm), evaluation was made as follows in the preferred order. L≦1.5: ∘, 1.5<L≦3.0:Δ, and 3.0<L: x.

Tables 4 to 7 describes a solidus temperature of the insert material, which was determined by the differential thermal analysis (DTA).

The starting point of a large endothermic peak whose peak height is 5 μV (the electromotive force of a thermocouple indicating the difference with the reference substance: μV) or higher, the endothermic peak being generated when the temperature of the test piece cut out from each of the above-mentioned test material was elevated from 450° C. to 700° C. at 5° C. min was set to the solidus temperature. In cases in which a plurality of subject endothermic peaks exist, the starting point of the endothermic peak on the lowest temperature may be set to the solidus temperature. The starting point was defined by a point where, when a line on the lower temperature side of the subject endothermic peak is extended to the higher temperature side, the line begins to change into a curve due to the endothermic peak and the extended line begins to departs from the line.

Tables 4 to 6 shows a variety of evaluation results for conditions in the scope of the present disclosure. As obvious from the results shown in the Table, for the manufacturing signs 001 to 119 of materials of the present disclosure, the pre-bake elongation and hemming workability were more favorable and other properties were also favorable.

Table 7 shows the test results of Comparative Examples which are out of the scope of the present disclosure. In Table 7, materials which are not used and items which are not evaluated are represented by “-”. For manufacturing signs 125 to 132, a large amount of joining interface peeling was generated during rolling, or a large amount of the material surface local swelling was generated after process annealing, thereby failing to evaluate the material. The manufacturing sign 144 will be described below as a reference example.

The single alloy materials (manufacturing sign 120 to 124) were poor in view of the performance balance compared with a test material (manufacturing signs 001 to 119) according to the present disclosure. On the other hand, the material of the present disclosure has a practical strength, and hemming workability as a material for forming while pre-bake elongation and corrosion resistance were balanced at a higher level compared with a single alloy material.

For the manufacturing signs 125, 126 in which only a core material and a surface material were layered in accordance with an ordinary method and was subjected to clad rolling, the manufacturing signs 127, 128 in which a high-temperature heating was performed at a temperature lower than the solidus temperature of an insert material, and manufacturing signs 129 to 132 in which the solidus temperature of an insert material was out of the scope of the present disclosure, an adhesion failure was generated.

Still further, for the manufacturing sign 133 in which the ratio of the surface material with respect to the total sheet thickness was below the defined range, the hemming workability and corrosion resistance were deteriorated compared with a material of the present disclosure material (for example, the manufacturing sign 028) comprising the same combination of the core material and surface material. On the other hand, for the manufacturing sign 134 in which the ratio of surface material with respect to the total sheet thickness was above the defined range, 0.2% proof stress before paint-baking and, 0.2% proof stress after paint-baking were considerably decreased compared with a material of the present disclosure material (for example, the manufacturing sign 067) comprising the same combination of the core material and surface material.

The manufacturing signs 016, 017, 078, and 079 of the example of the present disclosure are those to verify the effect of the high-temperature heat treatment in a non-oxidizing atmosphere, and the rolling reduction ratio of one pass thereof can be made larger compared with other materials of the present disclosure in which a high-temperature heat treatment was performed in an oxidizing atmosphere (in the air).

For the clad sheet material of the manufacturing signs 135 to 137 in which the composition of the core material was out of the upper limit defined by the present disclosure, the pre-bake elongation was deteriorated compared with the example of the present disclosure. For the clad sheet material of the manufacturing signs 138 and 139 in which the composition of the core material was out of the lower limit defined by the present disclosure, each of the pre-bake elongation, 0.2% proof stress before paint-baking and 0.2% proof stress after paint-baking was deteriorated compared with the example of the present disclosure.

For the clad sheet material of the manufacturing signs 140 to 142 in which the composition of the surface material was out of the upper limit defined by the present disclosure, the hemming workability or corrosion resistance was deteriorated compared with the example of the present disclosure. For the clad sheet material of the manufacturing signs 143 in which the composition of the surface material was out of the lower limit defined by the present disclosure, the surface hardness after paint-baking was deteriorated compared with the example of the present disclosure.

For the manufacturing sign 144, a pure aluminum having a high melting point which was much higher than that of the insert material was combined and a high-temperature heat treatment was performed in order to verify the technique used in the present disclosure for bonding the insert material and core material, or the insert material and surface material by utilizing a liquid phase of the insert material. A favorable bonding was confirmed after high-temperature heating in a similar manner to the material of the present disclosure. For the manufacturing sign 144, evaluation was not performed except for verifying the bonding performance.

### CROSS-REFERENCE TO RELATED APPLICATION

The present application is based on Japan Patent Application No. 2011-241444 filed on Nov. 2, 2011. The description, Claims, and Drawings thereof are incorporated herein by reference.

1. An aluminum alloy clad material for forming comprising:
an aluminum alloy core material containing Mg: 0.2 to 1.5% (mass %, the same hereinafter), Si: 0.2 to 2.5%, Cu: 0.2 to 3.0%, and the remainder being Al and inevitable impurities;
an aluminum alloy surface material that is cladded on one side or both sides the core material, the thickness of the clad for one side being 3 to 30% of the total sheet thickness, and that has a composition including Mg: 0.2 to 1.5%, Si: 0.2 to 2.0%, Cu being restricted to 0.1% or smaller, and the remainder being Al and inevitable impurities; and
an aluminum alloy insert material that is interposed between the core material and the surface material, and has a solidus temperature of 590° C. or lower.

2. The aluminum alloy clad material for forming according to claim 1, wherein
the core material and the surface material, or either thereof contains one or more of Mn: 0.03 to 1.0%, Cr: 0.01 to 0.40%, Zr: 0.01 to 0.40%, V: 0.01 to 0.40%, Fe: 0.03 to 1.0%, Zn: 0.01 to 2.5%, and Ti: 0.005 to 0.30%.

3. The aluminum alloy clad material for forming according to claim 1, wherein
setting the amount of Si (mass %, the same hereinafter) contained in the insert material to x and the amount of Cu (mass %, the same hereinafter) contained in the insert material to y, the following expressions (1) to (3) are satisfied at the same time:
x≧0 (1)
y≧0 (2)
y≧15.3x+2.3 (3).

4. The aluminum alloy clad material for forming according to claim 2, wherein
material to x, and the amount of Cu (mass %, the same hereinafter) contained in the insert material to y, the following expressions (4) to (6) are satisfied at the same time:
x≧0 (4)
y≧0 (5)
y≧−x+0.01 (6).

5. The aluminum alloy clad material for forming according to claim 1, wherein
the amount of Mg contained in the insert material is 0.05 to 2.0 mass %, and
setting the amount of Si (mass %, the same hereinafter) contained in the insert material to x, and the amount of Cu (mass %, the same hereinafter) contained in the insert material to y, the following expressions (4) to (6) are satisfied at the same time:
x≧0 (4)
y≧0 (5)
y≧−x+0.01 (6).

6. The aluminum alloy clad material for forming according to claim 2, wherein
the amount of Mg contained in the insert material is 0.05 to 2.0 mass %, and
setting the amount of Si (mass %, the same hereinafter) contained in the insert material to x, and the amount of Cu (mass %, the same hereinafter) contained in the insert material to y, the following expressions (4) to (6) are satisfied at the same time:
x≧0 (4)
y≧0 (5)
y≧−x+0.01 (6).

7. The aluminum alloy clad material for forming according to claim 1, wherein
the solidus temperature of the insert material is lower than the solidus temperature of the core material and the solidus temperature of the surface material.

8. The aluminum alloy clad material for forming according to claim 2, wherein
the solidus temperature of the insert material is lower than the solidus temperature of the core material and the solidus temperature of the surface material.

9. The aluminum alloy clad material for forming according to claim 3, wherein
the solidus temperature of the insert material is lower than the solidus temperature of the core material and the solidus temperature of the surface material.

10. The aluminum alloy clad material for forming according to claim 4, wherein
the solidus temperature of the insert material is lower than the solidus temperature of the core material and the solidus temperature of the surface material.

11. The aluminum alloy clad material for forming according to claim 5, wherein
the solidus temperature of the insert material is lower than the solidus temperature of the core material and the solidus temperature of the surface material.

12. The aluminum alloy clad material for forming according to claim 6, wherein
the solidus temperature of the insert material is lower than the solidus temperature of the core material and the solidus temperature of the surface material.

13. The aluminum alloy clad material for forming according to claim 1, wherein
the thickness of the insert material when the core material, the insert material and the surface material are bonded in a high-temperature heat treatment is 10 μm or larger.

14. The aluminum alloy clad material for forming according to claim 2, wherein
the thickness of the insert material when the core material, the insert material and the surface material are bonded in a high-temperature heat treatment is 10 μm or larger.

15. The aluminum alloy clad material for forming according to claim 3, wherein
the thickness of the insert material when the core material, the insert material and the surface material are bonded in a high-temperature heat treatment is 10 μm or larger.

16. The aluminum alloy clad material for forming according to claim 4, wherein
the thickness of the insert material when the core material, the insert material and the surface material are bonded in a high-temperature heat treatment is 10 μm or larger.

17. The aluminum alloy clad material for forming according to claim 5, wherein
the thickness of the insert material when the core material, the insert material and the surface material are bonded in a high-temperature heat treatment is 10 μm or larger.

18. The aluminum alloy clad material for forming according to claim 6, wherein
the thickness of the insert material when the core material, the insert material and the surface material are bonded in a high-temperature heat treatment is 10 μm or larger.

19. The aluminum alloy clad material for forming according to claim 7, wherein
the thickness of the insert material when the core material, the insert material and the surface material are bonded in a high-temperature heat treatment is 10 μm or larger.

20. The aluminum alloy clad material for forming according to claim 8, wherein
the thickness of the insert material when the core material, the insert material and the surface material are bonded in a high-temperature heat treatment is 10 μm or larger.
